(19) United States
(12) Patent Application Publication
(10) Pub. No.: US 2010/0054274 A1
(43) Pub. Date: Mar. 4, 2010

(54) Method for clock synchronization in a communication network, and communication network

(76) Inventors: Florian Breyer, München (DE); Sebastian Randel, München (DE); Johannes Riedl, Ergolding (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/547,797

(22) Filed: Aug. 26, 2009

(30) Foreign Application Priority Data
Aug. 26, 2008 (DE) 10 2008 039 793.8

(51) Int. Cl. H04L 12/43

(52) U.S. Cl. 370/458

(57) ABSTRACT

A method for clock synchronization in a communication network, in particular one based on packet switched data transmission, is provided. A first clock signal from a first network element is used as a reference signal for synchronization of a respective second clock signal from one or more second network elements. The first clock signal is transmitted at a transmission frequency intended exclusively for the clock signal or at a transmission frequency band intended exclusively for the first clock signal to the one or the more second network elements. The first clock signal is processed in the respective second network element in order to adjust the second clock signal such that the second clock signal matches the first clock signal.

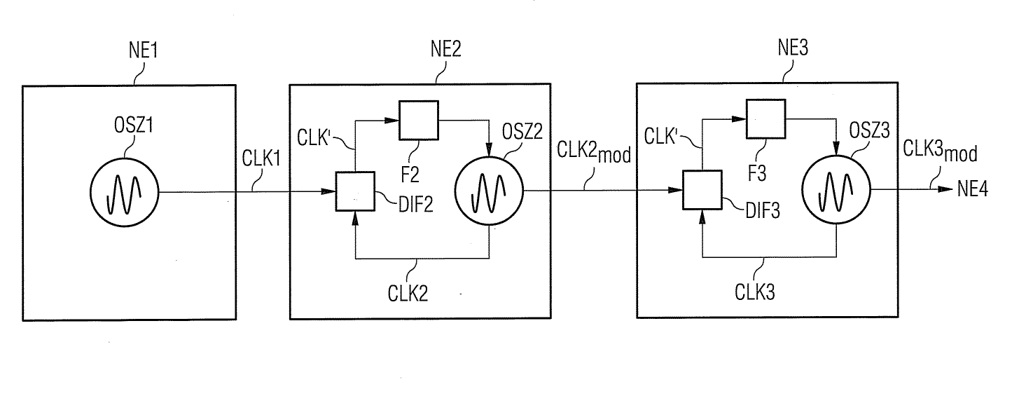

### CROSS REFERENCE TO RELATED APPLICATIONS

This application claims priority of German Patent Application No. 10 2008 039 793.8 DE filed Aug. 26, 2008, which is incorporated by reference herein in its entirety.

### FIELD OF INVENTION

The invention relates to a method for clock synchronization in a communication network, in particular one based on packet switched data transmission, whereby a first clock signal from a first network element is used as a reference signal for synchronization of a respective second clock signal from one or more second network elements.

The invention also relates to a communication network, which in particular is based on packet switched data transmission, comprising a first network element for delivering a first clock signal as a reference signal for synchronization of a respective second clock signal from one or more second network elements of the communication network.

### BACKGROUND OF INVENTION

In a communication network based on packet switched data transmission, such as Ethernet for example, a synchronization of so-called clocks is necessary in respective network elements. The clocks, which are represented for example by means of a counter value, are based on an oscillator frequency made available in a respective network element. Starting from a so-called master clock in the first network element, the so-called master, the clocks of all the other, second network elements of the communication network are to be synchronized to the clock of the master. In this situation, there frequently exists the requirement that the synchronization needs to take place in a very short period of time with a very high degree of precision.

Time synchronization mechanisms in packet switched communication networks are described in the IEEE 1588 and IEEE 802.1as standards. In these, synchronization messages containing a current time in the master are sent regularly by the master to the other network elements of the communication network. The other network elements are informed regularly by means of these synchronization messages about the current time in the master. On the basis of this information, the other network elements are able to correct their own, local time accordingly.

The transmission of the synchronization messages lasts a certain period of time on account of forwarding delays and propagation delays, whereby these periods of time exhibit jitter for a variety of reasons. A processing delay (forwarding delay) occurs for example when the message passes through a switch as a network element. A propagation delay occurs for example during the transmission of the message along a cable system or along the propagation path. The master time specified in the synchronization messages must therefore be corrected by the forwarding delay and the propagation delay by each network element.

In order to be able to perform this correction, the delays must be known to the corresponding second network elements. The forwarding delay is as a general rule measured or estimated for the hardware employed for the network element. The corresponding values are passed or conveyed to the second network elements as parameters by means of a configuration. The propagation delay is determined regularly by way of the exchange of specified messages, which contain so-called time stamps, between adjacent network elements.

The known time synchronization mechanisms are thus based on the principle of correcting the local time of the second network elements from the information known through the exchange of messages in order to arrive at the time in the master. By implication, the mechanism described takes into consideration the correction of significant changes in the oscillator frequencies, from which the times are derived, in the respective network elements. The changes result from changing ambient conditions (such as for example temperature fluctuations, vibrations affecting individual network elements etc.). When this method is used, the synchronism of clocks of the network elements can however only be restored again after a certain period of time, which typically lies in a time scale of seconds. The clocks may also differ greatly from one another during this relatively long synchronization phase. There is however frequently a requirement for a synchronism of the clocks within much shorter periods of time, in other words within fractions of a second, and also a guaranteed maximum deviation of 1 microsecond even during the synchronization phase.

The known concepts for time synchronization, as described in IEEE 1588 or IEEE 802.1as and previously, have the following disadvantages:
The more network elements are situated between the master (first network element) and a second network element which is to be synchronized, the greater are the deviations which can occur between the master time and the local time of the second network element to be synchronized. An error propagation or intensification thus occurs.
In the case of a rapid or erratic change in the properties of an oscillator crystal, for example as a result of a temporary sharp increase in temperature or a vibration, the time synchronization is very slow-acting, in other words a certain period of time may elapse before the desired synchronism is restored again, which is however unacceptable in many cases.
As a result of the high levels of imprecision occurring during the transmission of synchronization messages, a required synchronization precision of one microsecond can only be achieved in small linear networks having less than 100 network elements. The high level of imprecision occurring during message transmission results from the packet-oriented character of the communication network and from the dwell times of the packets in the respective network elements, which are not exactly predictable.

### SUMMARY OF INVENTION

An object of the present invention is therefore to specify a method which enables a synchronization of clocks of network elements in communication networks, in particular those based on packet switched transmission, to be achieved as rapidly and precisely as possible. A further object of the present invention is to specify a communication network in which a synchronization of clocks of respective network elements can be achieved as precisely as possible.

These objects are achieved by a method and a communication network as claimed in the independent claims. Advantageous embodiments are set down in the dependent claims.

The invention creates a method for clock synchronization in a communication network, in particular one based on packet switched data transmission, whereby a first clock signal from a first network element is used as a reference signal for synchronization of a respective second clock signal from one or more second network elements. With regard to the method, the first clock signal is transmitted at a transmission frequency intended exclusively for the first clock signal or at a transmission frequency band intended exclusively for the first clock signal to the one or the more second network elements. The first clock signal is processed in the respective second network element in order to adjust the second clock signal such that the second clock signal matches the first clock signal.

The invention also creates a communication network, in which in particular user data is transmitted on a packet switched basis, comprising a first network element for delivering a first clock signal as a reference signal for synchronization of a respective second clock signal from one or more second network elements of the communication network, whereby the first clock signal can be transmitted at a transmission frequency intended exclusively for the first clock signal or at a transmission frequency band intended exclusively for the first clock signal to the one or the more second network elements, and whereby the first clock signal can be processed in the second network element in order to adjust the second clock signal such that the second clock signal matches the first clock signal.

The invention is based on the idea of reserving one frequency or a narrow frequency band on the physical transmission layer for the adjustment of respective oscillator frequencies or clock signals in order to synchronize the clock in respective network elements. Since within the scope of the invention the clock synchronization is effected exclusively by way of the physical layer, a much greater level of precision is achieved than is the case with the synchronization mechanisms known from the prior art. Moreover, by decoupling the synchronization from the data transmission in particular in communication networks based on packet switched data transmission it is possible when comparing the clocks, or clock rates, of the two network nodes under consideration to avoid oscillations being observed which decay only after an extended period of time. A synchronization of the clocks and times which is as precise and direct as possible is necessary both for certain applications, such as for example mobile handover in wireless communication networks, and also for implementing predefined functions or properties of the associated packet switched data network, such as for example the determination of scheduling cycles for implementing isochronous realtime services.

According to one embodiment, a data transmission between the first network node and one of the second network nodes in the communication network is based on a frequency-division multiplex process (FDM), whereby the transmission frequency used for the clock synchronization in particular does not overlap with a transmission frequency used for the data transmission.

The first clock signal is transmitted on the physical carrier medium as an analog signal to the one or more second network elements. In order to make the data which is relevant to the synchronization accessible in the case of the recipient, one of the second network elements, it is simply necessary to perform a filtering or separation of the frequency or frequency band used for the synchronization from the frequency or frequency band used for the data transmission.

The first clock signal and the second clock signal are derived from an oscillator in the respective first network element and second network element. In particular, in the second network element a phase difference is ascertained as a control variable between the frequencies of the first clock signal and the second clock signal and the phase difference is used in order to adjust the frequency of the second clock signal to the frequency of the first clock signal. This means that the clock signals of the oscillators of the second network elements can be controlled. In particular, the oscillators in question in the second network elements are actively alterable oscillators, such as for example voltage controlled oscillators (VCO) or voltage controlled crystal oscillators (VCXO).

The reference signal transmitted from the first network element to the second network element is thus used in the second network element in order to correct the oscillator responsible there for the local time such that the oscillators in the two adjacent network nodes yield the same frequency and are thus synchronized. The synchronized second clock signal can thus be transmitted as a reference signal to a further adjacent second network element for synchronizing the latter.

According to one variant, the first clock signal is transmitted by wire using an electrical line or an optical line to the one or more second network elements. In another variant, the first clock signal is transmitted wirelessly by way of a dedicated transmission channel from the first network element to the second network element. The clocks of network elements in a communication network can thus be synchronized for any given physical transmission media.

According to a further embodiment of the method according to the invention, the communication network has one first network element and a plurality of second network elements, which at least in part have respective communication connections to one another, whereby for the purpose of clock synchronization, starting from the first network element, a logical tree structure is generated, and on all the physically present communication connections which are not contained in the logical tree structure the first clock signal or a second synchronized clock signal is filtered out or blocked or disregarded. The clock synchronization, as has been proposed hitherto, can thus be used not only in linear or treelike communication networks. In fact, usage in intermeshed networks is also possible. For this purpose, a logical tree structure is defined for example by means of the RSTP (Rapid Sparning Tree Protocol) protocol on the physically intermeshed communication network, whereby on all connections, which although they are present in the physical topology do not however appear in the logical tree structure, a blocking or handling of the synchronization frequency signal/frequency band takes place.

In a further embodiment, in addition to the clock synchronization described previously a first counter value corresponding to the current time of the first network element is used as a reference value for synchronization of a respective second counter value of the one or more second network elements, whereby at least one counter value synchronization message is sent out by the first network element to the one or more second network elements, whereby the one or more second network elements process the first counter value of the first network element contained in the counter value synchronization message in order to correct their respective second counter value. According to this embodiment, the inventive clock synchronization is combined with an offset synchronization mechanism such that a precise time synchronization can be provided in the network elements of the communication network.

Advantageously, the first counter value is corrected in a respective second network element by a forwarding delay and/or by a propagation delay. In order to determine the forwarding delay and/or the propagation delay, messages are exchanged between the first and the one or more second network elements. It is advantageous if the synchronization of a respective second counter value, in particular the processing of the counter value synchronization message and/or the determination of the forwarding delay and/or the propagation delay, takes place in accordance with the IEEE 1588 or IEEE 802.1as standard.

The invention can thus be combined with known offset synchronization mechanisms, such as have already been described in the introduction. The following advantages or enhancements results from this combination:
The error propagation of the combination of the proposed clock synchronization with the described offset synchronization is less by several orders of magnitude than the time synchronization as was described in the introduction in the description of the prior art.
The effects of changes in the ambient conditions become infinitesimally small because there an immediate reaction to a change in an ambient condition and a correction of the corresponding frequencies occurs and an asynchronism of the times following a single synchronization is thus largely avoided.
As a result of the considerably enhanced behavior in respect of error propagation and ambient effects, the clock synchronization described facilitates a high level of precision of the time synchronization even in very large communication networks.

The procedure according to the invention is based on the provision of a separate frequency for a clock signal on the same physical medium that is also used for the data communication, by way of which the clock synchronization then takes place in analog fashion and in particular without analog to digital conversion. This serves to ensure that the data communication is not impaired by the use of the separate frequency or of the frequency band for the clock signal. This yields the following advantages compared with known methods:
Since with the method according to the invention the clock synchronization takes place exclusively by way of the physical carrier medium (the physical layer), a greater level of precision is achieved than in the prior art.
In the event of a change in a frequency of one of the oscillators of a node compared with the oscillator of the master node, an immediate adjustment of the frequency of the former node takes place.
Since the time synchronization is required not only for applications but also for the associated packet switched communication network in order to implement certain functions or properties, a decoupling of the synchronization from the packet switched transmission avoids the situation where the state of the data network and in particular its load state has a negative effect on the clock synchronization.

### BRIEF DESCRIPTION OF THE DRAWINGS

The invention will be described in detail in the following with reference to an embodiment in the drawing.

### DETAILED DESCRIPTION OF INVENTION

The single figure shows a schematic illustration of a linear communication network with three network elements NE1, NE2, NE3 by way of example. In the communication network illustrated a communication connection exists between the network element NE1 and the network element NE2 and also between the network element NE2 and the network element NE3 etc. The communication between two adjacent network elements can take place in wired or wireless fashion. Packet switched data transmission is assumed for the data transmission, whereby this takes place at a dedicated frequency or a dedicated frequency band by way of the physical transmission medium. The communication network can for example be implemented as an Ethernet.

In a known manner, each of the network elements NE1, NE2, NE3 has at its disposal an oscillator OSZ1, OSZ2, OSZ3, each of which delivers an oscillation at a predefined frequency. From this sinewave clock signal can be derived a time (a counter value for example) which is required for the operation of a respective network node. The clock signal CLK1 from the oscillator OSZ1 of the network element NE1 is used as a reference signal for synchronization of the clock signals of the network elements NE2, NE3, etc. For this reason, the network element NE1 constitutes a so-called master. According to the invention, the clock signal CLK1 from the network element NE1, in other words the oscillation generated by the oscillator OSZ1, is transmitted to the adjacent network element NE2 at a transmission frequency intended exclusively for the clock signal CLK1 or at a transmission frequency band intended exclusively for the clock signal CLK1. Advantageously in this situation these is no overlap between the frequency or the frequency band of the clock signal CLK1 and the frequency or frequency band used for the data transmission between the network element NE1 and the network element NE2. The transmission of the clock signal and of the data takes place in this case by way of the same physical transmission medium.

The clock signal CLK1 is fed to a first input of a phase difference detector DIF2 in the network element NE2. A clock signal CLK2 obtained from the oscillator OSZ2 in the network element NE2 is fed to a second input of the phase difference detector DIF2. The phase difference detector DIF2 forms the difference between the clock signals CLK1, CLK2, which is output at the output of the phase difference detector. The difference signal is denoted by CLK′ This signal can be fed either directly to a control input of the controllable oscillator OSZ2 or—as illustrated in the exemplary embodiment—by way of a lowpass filter F2 to the control input of the oscillator OSZ2. With regard to the oscillator OSZ2, this is an oscillator whose frequency is actively alterable. The oscillator OSZ2 can for example be implemented as a voltage controlled oscillator (VCO) or voltage controlled crystal oscillator (VCXO).

The difference signal CLK′ formed from the clock signals CLK1, CLK2 serves to zero the phase difference between the clock signals CLK1, CLK2 such that the synchronized clock signal CLK2 matches the clock signal CLK1. The oscillators OSZ1 in the network element NE1 and the network element NE2 are thus synchronized with one another. The synchronization of the oscillator OSZ3 in the further network element NE3 is effected by way of the synchronized clock signal from the oscillator OSZ2, which is denoted in the figure by CLK2_{mod}. In other words, the synchronized clock signal CLK2_{mod} constitutes the reference signal for the phase difference detector DIF3 in the network element NE3. The configuration of the further network element NE3 corresponds in this case to the configuration of the network element NE2.

According to the invention, the clock signal utilizes a separate frequency or a separate frequency band on the same physical transmission medium which also utilizes packet switched data communication but which does not interfere with the latter in any way. In particular, a frequency or a frequency band is used which does not overlap with the frequency/frequency band utilized for the data transmission. If the invention is used with existing transmission technologies, this frequency band should be determined in such a manner that it does not overlap with the frequencies used for data transmission. With regard to newly-developed transmission technologies, it is possible to ensure a freedom from overlap between the frequency or the frequency band for the synchronization and the frequencies for the data transmission, whereby no further restrictions exist. In comparison with conventional methods, a greater level of precision can be achieved by this means with regard to the synchronization of the clocks of adjacent network elements. Likewise, when there is a change in a crystal frequency, a quasi immediate adjustment of the frequency of the adjacent network element takes place.

The proposed clock synchronization can be combined with other offset synchronization mechanisms, such as for example those from the IEEE 1588 and IEEE 802.1as standards. This combination results in a highly precise time synchronization which avoids or rectifies the weaknesses stated in the introduction. In particular, the error propagation of the clock and time synchronization can be reduced by several orders of magnitude compared with the conventional offset synchronization mechanism. The effects of changes in the ambient conditions become infinitesimally small because there an immediate reaction to any external influence and a correction of the corresponding frequencies occurs. Furthermore, a high level of precision of the time synchronization can also be achieved in very large communication networks comprising far in excess of 100 network elements.

A linear communication network is illustrated in the exemplary embodiment. The invention can be used not only in linear or treelike communication networks but also in intermeshed communication networks. For this purpose, a quasi-linear or treelike communication network must be established, whereby this takes place through the definition of a logical tree structure on the physically intermeshed network. On all connections, which although they are present in the physical topology do not however appear in the logical tree structure, the synchronization frequency signal is then blocked or disregarded or filtered out. RSTP (Rapid Spanning Tree Protocol), for example, can be used as the protocol for the definition of a logical tree structure.

1.-13. (canceled)

14. A method for clock synchronization in a communication network based on packet switched data transmission, comprising:
providing a first clock signal of a first network element used as reference signal for a synchronization of a second clock signal of a second network element;
transmitting the first clock signal at a transmission frequency intended exclusively for the clock signal or at a transmission frequency band intended exclusively for the clock signal to the second network element; and
processing the first clock signal in the second network element in order to adjust the second clock signal such that the second clock signal matches the first clock signal.

15. The method as claimed in claim 14, further comprising:
transmitting data between the first and the second network element based on a frequency-division multiplex process.

16. The method as claimed in claim 15, wherein the transmission frequency used for the clock synchronization does not overlap with a further transmission frequency used for the data transmission.

17. The method as claimed in claim 14, wherein the first clock signal is transmitted on a physical carrier medium as an analog signal to the second network element.

18. The method as claimed in claim 14, wherein the first clock signal and the second clock signal are derived from an oscillator in the first network element and second network element.

19. The method as claimed in claim 14, further comprising:
ascertaining a phase difference in the second network element as a control variable between the frequencies of the first clock signal and the second clock signal; and
using the phase difference in order to adjust the frequency of the second clock signal to the frequency of the first clock signal.

20. The method as claimed in claim 14, wherein the first clock signal is transmitted by wire using an electrical line or an optical line to the second network element.

21. The method as claimed in claim 14, wherein the first clock signal is transmitted wirelessly via a dedicated transmission channel from the first network element to the second network element.

22. The method as claimed in claim 14, the communication network having one first network element and a plurality of second network elements, which at least in part have respective communication connections to one another, comprising:
generating a logical tree structure starting from the first network element for the purposes of clock synchronization.

23. The method as claimed in claim 22, further comprising:
filtering out the first clock signal or a second synchronized clock signal on all physically present communication connections which are not contained in the logical tree structure.

24. The method as claimed in claim 22, further comprising:
blocking the first clock signal or a second synchronized clock signal on all physically present communication connections which are not contained in the logical tree structure.

25. The method as claimed in claim 22, further comprising:
disregarding the first clock signal or a second synchronized clock signal on all physically present communication connections which are not contained in the logical tree structure.

26. The method as claimed in claim 14, further comprising:
using a first counter value of the first network element as a reference value for synchronization of a respective second counter value of the second network elements;
sending at least one counter value synchronization message by the first network element to the second network element; and
processing the first counter value of the first network element contained in the counter value synchronization message by the second network element in order to correct a second counter value.

27. The method as claimed in claim 26, wherein the first counter value is corrected in the second network element by a forwarding delay.

28. The method as claimed in claim 26, wherein the first counter value is corrected in the second network element by a propagation delay.

29. The method as claimed in claim 27, further comprising:
exchanging messages between the first and the second network element in order to determine the forwarding delay.

30. The method as claimed in claim 28, further comprising:
exchanging messages between the first and the second network element in order to determine the propagation delay.

31. The method as claimed in claim 26, wherein the synchronization of a second counter value, in particular the processing of the counter value synchronization message and/or the determination of the forwarding delay and/or the propagation delay, takes place in accordance with the IEEE 1588 or the IEEE 802.1as standard.

32. A communication network, comprising:
a first network element for delivering a first clock signal as a reference signal;
a second network element providing a second clock signal, the first clock signal being used for synchronization of the second clock signal,
wherein the first clock signal is transmitted at a transmission frequency intended exclusively for the first clock signal or at a transmission frequency band intended exclusively for the first clock signal to the second network element, and
wherein the first clock signal is processed in the second network element in order to adjust the second clock signal such that the second clock signal matches the first clock signal.

33. The communication network as claimed in claim 32, wherein user data are transmitted on a packet switched basis in the communication network.
